(19) United States
(12) Patent Application Publication
(10) Pub. No.: US 2005/0282047 A1
(43) Pub. Date: Dec. 22, 2005

(54) Method for operating fuel cell, fuel cell, and mobile device and mobile phone using same

(75) Inventors: Hidekazu Kimura, Tokyo (JP); Tsutomu Yoshitake, Tokyo (JP); Sadanori Kuroshima, Tokyo (JP); Takashi Manako, Tokyo (JP); Suguru Watanabe, Tokyo (JP); Yoshimi Kubo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 10/525,651

(22) PCT Filed: Sep. 26, 2003
(86) PCT No.: PCT/JP03/12306

§ 371 Date: Feb. 25, 2005

(30) Foreign Application Priority Data
Sep. 30, 2002 (JP) 2002-287786

(51) Int. Cl. H01M 8/04; H01M 4/86

(52) U.S. Cl. 429/4; 429/23; 429/44

(57) ABSTRACT

A fuel cell includes a fuel cell main unit (110) in which organic liquid fuel is supplied to a fuel electrode (102) as fuel, and a vibration generating unit (314, 324) which generates vibration to vibrate the fuel electrode (102) such that carbon dioxide generated at the fuel electrode is removed. The fuel cell may includes a control unit (463) which controls an operation of the vibration generating unit (314, 324) based on an output of the fuel cell main unit (110).

### TECHNICAL FIELD

The present invention relates to a fuel cell that uses an organic compound as a fuel, and an operation method of the same, a portable information device that have the same.

### BACKGROUND ART

A polymer electrolyte type fuel cell is an apparatus designed in such a way that a polymer electrolyte membrane, such as a perfluorosulfonic acid membrane, is used as an electrolyte and that a fuel electrode and an oxidant electrode are joined on both surfaces of this membrane, for supplying hydrogen to the fuel electrode and supplying oxygen to the oxidant electrode to thereby produce an electric power through an electrochemical reaction.

In the fuel electrode and the oxidant electrode, the electrochemical reactions are induced respectively as represented by the following reaction formulas (1) , (2):
Fuel Electrode: H₂→2H⁺+2e⁻ (1)
Oxidant Electrode: 1/20₂+2H⁺+2e⁻→H₂O (2)

Due to this reaction, the polymer electrolyte type fuel cell can obtain a high power output of 1 A/cm² or more at an ordinary temperature and an ordinary pressure.

Mixture of the polymer electrolyte and carbon particles on which catalyst substances are supported is placed on each of the fuel electrode and the oxidant electrode. Typically, this mixture is coated on an electrode substrate, such as a carbon paper and the like, which serves as a diffusion layer of fuel gas. The fuel cell is formed by sandwiching the polymer electrolyte between those two electrodes and pressing them thermally.

In this fuel cell, the hydrogen gas supplied to the fuel electrode passes through a penetration hole in the electrode, reaches the catalyst, discharges electrons and becomes hydrogen ions as shown in the above reaction formula (1). The discharged electrons are passed through the carbon particles within the fuel electrode and sent to an external circuit and then sent from the external circuit into the oxidant electrode.

On the other hand, the hydrogen ion generated in the fuel electrode passes through the polymer electrolyte in the fuel electrode and the polymer electrolyte membrane placed between both of the electrodes and reaches the oxidant electrode. This hydrogen ion reacts with the oxygen supplied to the oxidant electrode and the electron sent from the external circuit. Consequently, the water is generated as represented by the above-mentioned reaction formula (2). As a result, in the external circuit, the electrons flow from the fuel electrode to the oxidant electrode so that the electric power is taken out.

As mentioned above, the fuel cell using the hydrogen as the fuel has been described. In recent years, a fuel cell that uses an organic compound such as a methanol as a fuel has been vigorously researched and developed. Among the fuel cells, there is the fuel cell which reforms the organic compound into the hydrogen gas and then uses it as the fuel. Also, there is the fuel cell which is directly supplied the organic compound to the fuel electrode without reforming an organic liquid fuel, as represented by a direct methanol type fuel cell. Especially, the latter fuel cell has the structure of directly supplying the organic liquid fuel, such as the methanol and the like, to the fuel electrode. Thus, it does not require an apparatus such as a reforming unit. For this reason, the fuel cell can be configured as the simple unit and that the entire apparatus can be miniaturized. Also, as compared with the gaseous fuels of hydrogen gas, hydrocarbon gas and the like, the organic liquid fuel has the feature that it is superior in safety and portability. For this reason, the fuel cell using such organic liquid fuel is expected to be installed in a portable information devices such as a portable telephone, a note type of a personal computer, PDA (personal digital assistant) and the like, in future.

The water is generated in the oxidant electrode, as represented by the reactive formula (2). The following technique is proposed in order to remove it from the oxidant electrode.

In Japanese Laid Open Patent Application (JP-A 2002-184430) , the technique of the fuel cell is disclosed. The fuel cell in this technique includes a piezoelectric element and a vibrating plate in at least one of an oxidant flow path and a fuel flow path. By the vibration of the element and the vibrating plate, the water in the oxidant electrode is removed effectively. However, a manufacturing process cell and a structure of the fuel cell become complex.

Also, in Japanese Laid Open Patent Application (JP-A 2002-203585), the technique of the fuel cell is disclosed. The fuel cell in this technique includes a vibrator which vibrates one of a separator and a set of electrodes of a fuel electrode and an oxidant reacting electrode. By the vibrator, the water in the oxidant reacting electrode and the fuel electrode is removed. However, this requires another power supply for driving the vibrator. Thus, it is difficult to attain the sufficiently miniaturized and lightened fuel cell.

On the other hand, in the fuel cell using the organic liquid fuel, for example, the methanol, the removal of the carbon dioxide generated in the fuel electrode is the most important subject that will be described below.

The electrochemical reactions occurring in the oxidant electrode and the fuel electrode in the fuel cell using the methanol are respectively represented by the following reaction formulas (3), (4):
Fuel Electrode: CH₃OH+H₂O→CO₂+6H⁺+6e⁻ (3)
Oxidant Electrode: 3/20₂+6H⁺+6e⁻→3H₂O (4)

As represented by the reaction formula (3), carbon dioxide is generated in the fuel electrode. In order to produce the electric power smoothly, the methanol needs to be efficiently supplied to the surface of metal catalyst to vigorously induce the reaction of the reaction formula (3). However, in the conventional fuel cell, the carbon dioxide generated from the reaction formula (3) stays in the fuel electrode, and gas bubbles are formed. Consequently, there was the case that the catalyst reaction in the fuel electrode was obstructed. As a result, there was the case that a stable power output was not obtained.

In conjunction with the above description, Japanese Laid Open Patent Application (JP-A 2001-102070), the technique of a fuel cell is disclosed. The fuel cell of this technique includes an electrolyte membrane, a fuel electrode, a oxidant electrode, a fuel vessel and a separation membrane. The fuel electrode and the oxidant electrode are arranged both side of the electrolyte membrane. The fuel vessel holds liquid fuel on the surface of the electrode. The separation membrane is arranged on the fuel vessel, separates the carbon dioxide from the liquid fuel and exhausts the carbon dioxide generated in the fuel electrode from the fuel vessel selectively.

In Japanese Laid Open Patent Application (JP-A 2002-56856), the technique of a fuel cell which uses liquid fuel is disclosed. The fuel cell of this technique includes an electrolyte, a fuel electrode and an oxidant electrode with catalyst portions. In the boundary between the electrolyte and the catalyst portion of the fuel electrode, a flow groove for supplying the liquid fuel is formed on the surface of the electrolyte of the catalyst portion.

### DISCLOSURE OF INVENTION

Therefore, an object of the present invention is to provide a fuel cell and a portable information device, in which a carbon dioxide is efficiently removed from a fuel electrode, and a stable output is obtained.

Another object of the present invention is to provide a fuel cell and a portable information device, which has a simply manufacturing process and structure and a high power output.

In order to achieve an aspect of the present invention, the present invention provides a fuel cell including: a fuel cell main unit and a vibration generating unit. The fuel cell main unit includes a fuel electrode and an oxidant electrode, and generates electric power based on supplying of organic liquid fuel to the fuel electrode and oxidant to the oxidant electrode. The vibration generating unit which generates vibration to vibrate the fuel electrode such that carbon dioxide generated at the fuel electrode is removed.

The fuel cell of the present invention, further includes a control unit which controls an operation of the vibration generating unit based on an output of the fuel cell main unit.

The fuel cell of the present invention, further includes a power applying unit which outputs alternating electric power to the vibration generating unit, wherein the vibration generating unit is driven by the alternating electric power.

In the fuel cell of the present invention, the vibration generating unit is driven by a part of an output of the fuel cell main unit.

In the fuel cell of the present invention, the vibration generating unit includes a piezoelectric vibrator which generates the vibration.

In the fuel cell of the present invention, the vibration generating unit is arranged on the fuel cell main unit.

The fuel cell of the present invention, further includes a holding substrate on which holds the fuel cell main unit and the vibration generating unit. The holding substrate transmits the vibration to the fuel cell main unit.

In the fuel cell of the present invention, the fuel cell main unit includes a porous current collector that is coated by hydrophilic coating material.

In the fuel cell of the present invention, the fuel cell main unit includes a porous current collector that is coated by hydrophobic coating material.

In the fuel cell of the present invention, the fuel electrode includes a current collector and a fuel electrode catalyst layer. One side of the fuel electrode catalyst layer is connected to the current collector and another side is connect to a polymer electrolyte membrane. The current collector has holes which penetrate the current collector, diameters of the holes at a side of the fuel electrode catalyst layer are smaller than those at an opposite side.

In order to achieve another aspect of the present invention, the present invention provides a potable information device including a body and a fuel cell which is held on the body. The fuel cell includes a fuel cell main unit and a vibration generating unit. The fuel cell main unit is arranged in the body, includes a fuel electrode and an oxidant electrode, and generates electric power based on supplying of organic liquid fuel to the fuel electrode and oxidant to the oxidant electrode. The vibration generating unit is arranged in the body and generates vibration to vibrate the fuel electrode such that carbon dioxide generated at the fuel electrode is removed.

The potable information device of the present invention, further includes: a control unit which controls an operation of the vibration generating unit based on an output of the fuel cell main unit.

In the potable information device of the present invention, the fuel cell further includes: a power applying unit which outputs alternating electric power to the vibration generating unit, wherein the vibration generating unit is driven by the alternating electric power.

In the potable information device of the present invention, the vibration generating unit is driven by a part of an output of the fuel cell main unit.

In the potable information device of the present invention, the vibration generating unit includes a piezoelectric vibrator which generates the vibration.

In the potable information device of the present invention, the vibration generating unit is arranged on the fuel cell main unit.

In the potable information device of the present invention, the fuel cell further includes: a holding substrate on which holds the fuel cell main unit and the vibration generating unit. The holding substrate transmits the vibration to the fuel cell main unit.

In the potable information device of the present invention, the fuel cell main unit includes a porous current collector that is coated by hydrophilic coating material.

In the potable information device of the present invention, the fuel cell main unit includes a porous current collector that is coated by hydrophobic coating material.

In the potable information device of the present invention, the fuel electrode includes: a current collector; and a fuel electrode catalyst layer. One side of the fuel electrode catalyst layer is connected to the current collector and another side is connect to a polymer electrolyte membrane. The current collector has holes which penetrate the current collector, diameters of the holes at a side of the fuel electrode catalyst layer are smaller than those at an opposite side.

In the potable information device of the present invention, the body includes an outer body; an inner body which is contained in the outer body; and a vibration damping material which connects the outer body and the inner body. The fuel cell is held on the inner body.

In the potable information device of the present invention, further includes an information notifying unit which is arranged on the inner body, transmits the vibration to the outer body and notifies information to a user by vibrating the outer body based on the vibration.

In the potable information device of the present invention, the vibration generating unit is combined with a information notifying unit which transmits the vibration to the body and notifies information to a user by vibrating the body based on the vibration.

In the potable information device of the present invention, the vibration damping material includes butyl rubber.

In order to achieve still another aspect of the present invention, the present invention provides an operation method of a fuel cell, including: (a) generating electric power by supplying organic liquid fuel to a fuel electrode and oxidant to an oxidant electrode of the fuel cell; and (b) vibrating the fuel electrode such that carbon dioxide generated at the fuel electrode is removed.

In the operation method of a fuel cell of the present invention, the vibration is generated by a piezoelectric vibrator to which alternating current is supplied.

In the operation method of a fuel cell of the present invention, the vibration is generated by using a part of output current of the fuel cell.

In the operation method of a fuel cell of the present invention, the step (b) includes: (b1) vibrating the fuel electrode when an output of the fuel cell is lower than a threshold value.

According to the present invention, it is possible to provide the fuel cell in which since the fuel cell includes the vibration generating unit, the carbon dioxide is efficiently removed from the fuel electrode, and the stable output is obtained.

### BRIEF DESCRIPTION OF DRAWINGS

FIG. 1 is a diagrammatic view showing a configuration of a fuel cell of this embodiment according to the present invention;

FIG. 2 is a sectional view showing a generating portion of the fuel cell main unit in FIG. 1;

FIG. 3A is a sectional view showing a portable telephone as one of portable information devices in this embodiment;

FIG. 3B is a AA′ sectional view of FIG. 3A;

FIG. 4 is another sectional view showing a portable telephone as one of portable information devices in this embodiment;

FIG. 5 is another sectional view showing a generating portion of the fuel cell main unit in FIG. 1;

FIG. 6A is a block diagram showing the example of the configuration of the fuel cell with the control function;

FIG. 6B is a block diagram showing the example of the feedback control performed by the vibration control unit;

FIG. 6C is a view showing an example of a circuit configuration between the first voltage meter and the second voltage meter in FIG. 6A; and

FIG. 7 is a flowchart showing an example of the operation of the embodiment of the fuel cell according to the present invention.

### BEST MODE FOR CARRYING OUT THE INVENTION

(First Embodiment)

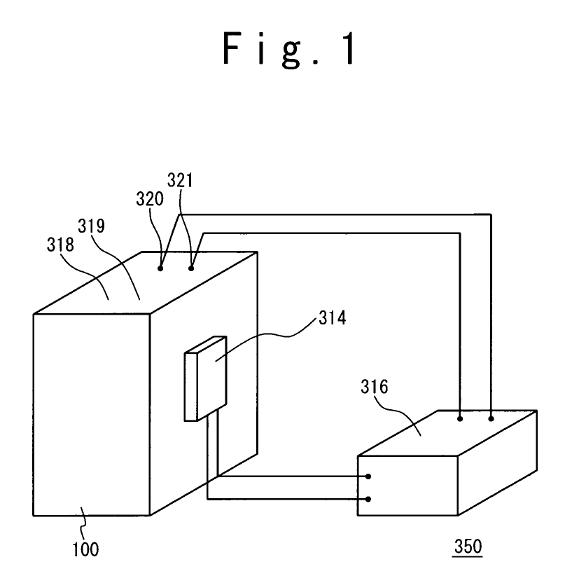

FIG. 1 is a diagrammatic view showing a configuration of a fuel cell of this embodiment according to the present invention. This fuel cell 350 includes a fuel cell main unit 100, an inverter device 316 and a piezoelectric vibrator 314, and the piezoelectric vibrator 314 as a vibration generating unit. The fuel cell main unit 100 has the four terminals of a first plus terminal 318, a first minus terminal 319, a second plus terminal 320 and a second minus terminal 321. The first plus terminal 318 and the first minus terminal 319 are the terminals so that it is connected to an external circuit. On the other hand, the second plus terminal 320 and the second minus terminal 321 are designed such that the fuel cell main unit 100 and the piezoelectric vibrator 314 are electrically connected through the inverter device 316 to each other, as shown in FIG. 1. A current flowing between the first plus terminal 318 and the first minus terminal 319, and a current flowing between the second plus terminal 320 and the second minus terminal 321 are branched by a branching unit (not shown).

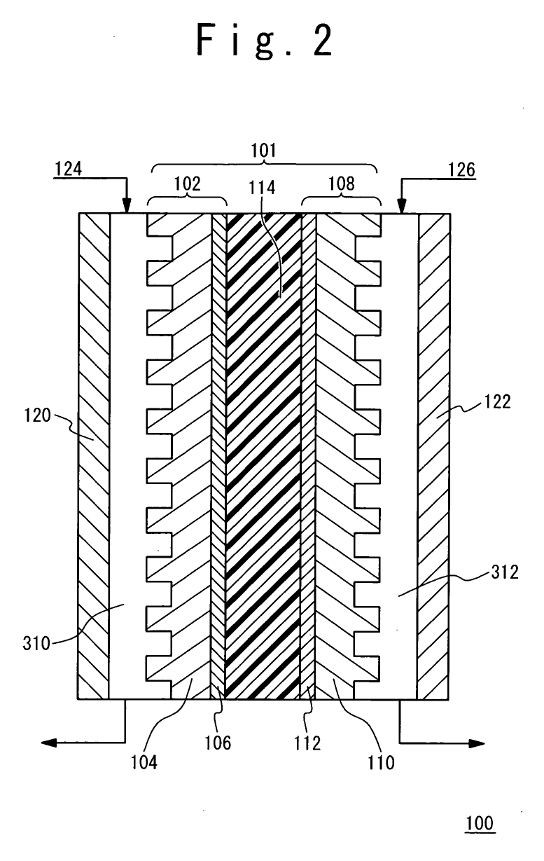

FIG. 2 is a sectional view showing a generating portion of the fuel cell main unit 100 in FIG. 1. An electrode-electrolyte assembly 101 includes a fuel electrode 102, an oxidant electrode 108 and a polymer electrolyte membrane 114. The fuel electrode 102 is composed of a fuel electrode side (current) collector 104 and a fuel electrode side catalyst layer 106. The oxidant electrode 108 is composed of an oxidant electrode side (current) collector 110 and an oxidant electrode side catalyst layer 112. The fuel electrode side collector 104 and the oxidant electrode side collector 110 have a large number of penetration holes (not shown), respectively.

A plurality of electrode-electrolyte assemblies 101 are laminated while sandwiched between a fuel electrode side separator 120 and an oxidant electrode side separator 122, and they are electrically connected to thereby constitute the fuel cell main unit 100.

A fuel path 310 through which a fuel 124 is supplied is formed between the fuel electrode side separator 120 and the fuel electrode side collector 104. Also, an oxidant path 312 through which an oxidant 126 is supplied is formed between the oxidant electrode side separator 122 and the fuel electrode side collector 104.

In the fuel cell main unit 100 as mentioned above, the fuel 124 is supplied through the fuel path 310 to the fuel electrode 102 of each of the electrode-electrolyte assemblies 101. The fuel 124 passes through the penetration holes of the fuel electrode side collector 104 and reaches the fuel electrode side catalyst layer 106. Then, it is used for the above-mentioned reaction shown in the reaction formula (3). This results in the generations of hydrogen ions, electrons and carbon dioxide. The hydrogen ions are passed through the polymer electrolyte membrane114 and moved to the oxidant electrode 108. Also, the electrons are moved through the fuel electrode side collector 104 and the external circuit to the oxidant electrode 108.

On the other hand, the oxidant 126, such as air, oxygen and the like, is supplied through the oxidant path 312 to the oxidant electrode 108 of each electrode-electrolyte assembly 101. This oxygen, the hydrogen ion which is generated in the fuel electrode 102 and moved to the oxidant electrode 108 as mentioned above, and the electron react with each other, as shown in the reaction formula (4), and then generates the water. In this way, the electron flows into the external circuit, from the fuel electrode 102 to the oxidant electrode 108. Thus, the electric power is produced. Here, since only the carbon dioxide is not moved to the oxidant electrode 108, it needs to be exhausted from the fuel electrode 102. The carbon dioxide is gas at the ordinary pressure. Thus, if the fuel cell main unit 100 is set at an open system, it is naturally removed somewhat as the gas bubbles from the fuel electrode 102. However, if a considerable amount of the gas bubbles of the carbon dioxide stay in the fuel electrode 102, the movement of the fuel 124 to the fuel electrode side catalyst layer 106 is obstructed. Hence, there may be a case that the reaction of the reaction formula (3) is not smoothly progressed. In this case, the power output can not be obtained stably.

So, in this embodiment, the piezoelectric vibrator 314 shown in FIG. 1 applies the vibration to the fuel electrode 102 to thereby urge the movement of the gas bubbles of the carbon dioxide. Consequently, the amount of the carbon dioxide staying in the fuel electrode 102 can be reduced to smoothly progress the reaction of the reaction formula (3) and thereby obtain the stable power output.

The vibration of the piezoelectric vibrator 314 is generated as follows. A part of a direct current outputted from the fuel cell main unit 100 is supplied to the inverter device 316 and converted into an alternating current. Next, this alternating current is supplied to the piezoelectric vibrator 314 to thereby generate the vibration. Since this vibration is transmitted to the entire fuel cell main unit 100, the vibration is also transmitted to the fuel electrode 102. Thus, it is possible to attain the separation of the carbon dioxide as mentioned above.

When the fuel cell is used for the portable information device, it is desirable to supply the electric power from the fuel cell main unit 100 to the inverter device 316. Because it is difficult for the portable information device to be supplied the electric power from other external power source. It is desirable for the piezoelectric vibrator 314 to be arranged on the surface of the fuel cell main unit 100 where the fuel electrode 108 is near. Because it is easy to transmit the vibration generated by the piezoelectric vibrator 314 to the fuel electrode 108.

In the piezoelectric vibrator 314, the characteristic of piezoelectric ceramics is used in which it is distorted by applying a voltage. For this reason, the vibration can be generated also by intermittently sending the direct current into the piezoelectric vibrator 314. However, if as described in this embodiment, the inverter device 316 converts into the alternating current to thereby drive the piezoelectric vibrator 314, it is possible to generate the vibration of which the displacement is equal to twice as that of the direct current. Thus, since the stronger vibration can be applied to the fuel electrode 102, the carbon dioxide can be removed much effectively.

As the piezoelectric vibrator 314, it is possible to use the piezoelectric vibrator, for example, such as a bi-morph type, a mono-morph type, and a uni-morph type. Especially, the bi-morph type piezoelectric vibrator is preferable. This is because the electric power consumption is small and the large amount of the displacement can be obtained at a low voltage. As such a bi-morph type piezoelectric vibrator, it is possible to use, for example, a piezoelectric ceramic actuator made by TFT Incorporated Company.

As the inverter device 316, it is possible to use, for example, a TCXF series made by Matsushita Electronic Components Co., Ltd, and the like.

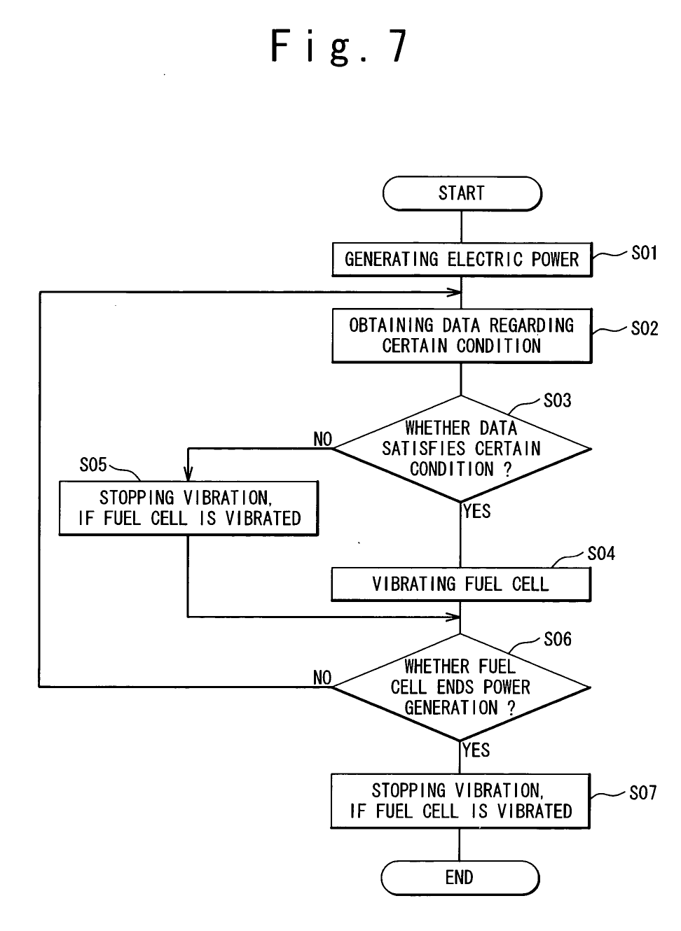

Here, the above-mentioned vibration may be always generated. However, for example, the vibration may be generated when predetermined condition is satisfied. Here, the predetermined condition is exemplified in the condition in which the power output of the fuel cell main unit 100 becomes lower than a threshold, the certain period of time (threshold) passes since the power start of the fuel cell main unit 100, the certain amount of power output (threshold) is consumed, and the certain value of electric current (threshold) flows. The process is shown in FIG. 7.

FIG. 7 is a flowchart showing an example of the operation of the embodiment of the fuel cell according to the present invention. At first, the fuel cell starts to generate the electric power (step S01). Next, the data (ex. the output of the fuel cell main unit, the period of time since the current flows, the amount of power output, and the value of the current) regarding the certain condition is obtained (step S02). The data is compared to the threshold (step S03) . When the data satisfies the certain condition (step S03, Yes), the fuel cell is vibrated (step S04). When the data does not satisfy the certain condition (step S03, No), if the fuel cell is vibrated, the vibration is stopped (step S05) . When the fuel cell continues the power generation (step S06, No) the process goes back to step S02. When the fuel cell stops the power generation (step S06, Yes), if the fuel cell is vibrated, the vibration is stopped (step S07).

By this, the electric power consumption of the piezoelectric vibrator 314 can be reduced.

Further, a feedback control may be carried out.

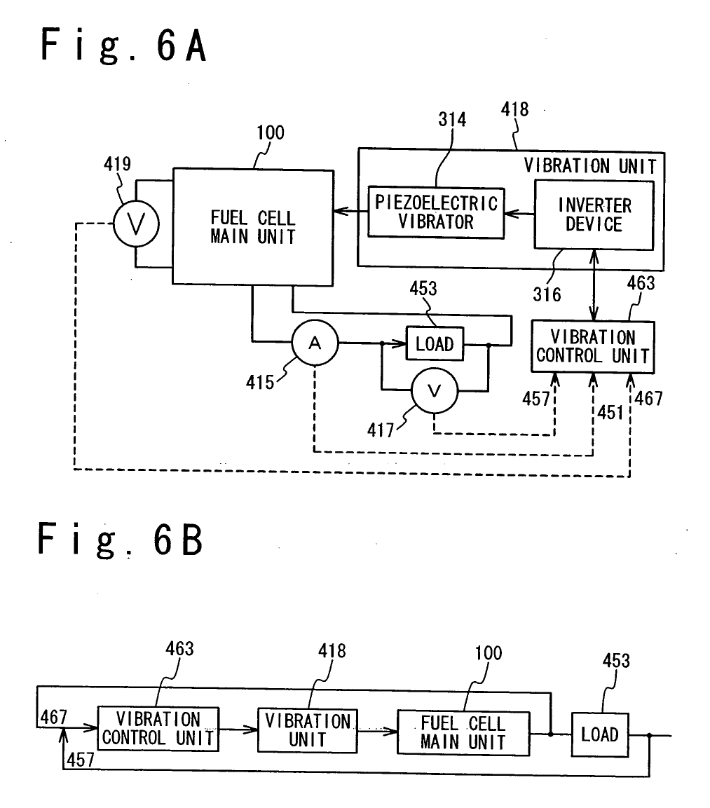

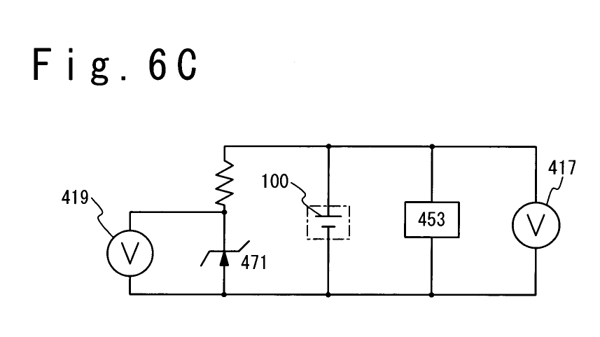

Specifically, for example, the control may be carried out by applying the configuration shown in FIG. 6A.

FIG. 6A is a block diagram showing the example of the configuration of the fuel cell with the control function.

In FIG. 6A, the piezoelectric vibrator 314 of the vibration unit 318 is controlled by the vibration control unit 463 through the inverter device 316. The vibration control unit 463 may be included in an inverter device 316. The first voltmeter 417 is connected to the load 453 and the second voltmeter 419 is connected to the fuel cell main unit 100. The ammeter 415, which measures the current from the fuel cell main unit 100 to the load 453, is connected to the line to the load 453. The outputs from the first voltmeter 417, the second voltmeter 419 and the ammeter 415 are supplied to the vibration control unit 463, as a current 451, an output 457 from the load 453, and a reference output 467, respectively. The vibration control unit 463 controls the inverter device 316 to turn on in case, for example, that the output 457 of the fuel cell main unit 100 becomes lower than a threshold value, the certain period of time passes since the current 451 flows, the certain amount of power output (the output 457×the current 451) is consumed, and the certain scale of the current 451 flows.

FIG. 6B is a block diagram showing the example of the feedback control performed by the vibration control unit 463. In FIG. 6B, the output 457 and the reference output 467 are supplied to the vibration control unit 463. The vibration control unit 463 carries out a calculation (ex. difference, ratio) with them as variables. Then, it compares the value calculated with a predetermined threshold value. In case that the value calculated is lower than the threshold, the vibration control unit 463 performs the feedback control which control the vibration of the piezoelectric vibrator 314. For example, the vibration control unit 463 carries out the PID (proportional plus integral plus derivative) control based on the output 457 and the reference output 467, and outputs the control signal which controls the inverter device 316.

The inverter device 316 is driven based on the control signal outputted by the vibration control unit 463. Then, the vibration is generated from the piezoelectric vibrator 314, and the gas bubbles of the carbon dioxide are removed from the fuel electrode 102. Thus, the output of the fuel cell main unit 100 is increased. On the other hand, if the above-mentioned ratio or difference exceeds the threshold value, the vibration control unit 463 stops the inverter device 316. Since the operation is done while the feedback control is done as mentioned above, the piezoelectric vibrator 314 can be efficiently driven. Hence, the stable electric power production can be maintained without increasing the load.

FIG. 6C is a view showing an example of a circuit configuration between the first voltage meter 417 and the second voltage meter 419 in FIG. 6A. This is an example in which a Zener diode 471 is placed in parallel to the fuel cell main unit 100. The installation of the Zener diode 471 enables a certain reference output to be obtained, and this can be detected by the second voltage meter 419.

The above-mentioned example is the controlling method when the reference output 467 is set to compare with the output 457 from the load 453. However, the supply of the fuel 124 can be attained even by a method that detects only the output from the fuel cell main unit 100 without setting the reference output 467 and then changes a frequency or a voltage of the inverter device 316 so that this output becomes constant.

Also, as for the feedback control, in addition to the above-mentioned method of generating the vibration only when the output becomes lower than the predetermined threshold value, for example, it is allowable to carry out a feedback for generating a vibration at a predetermined number of vibrations, on the basis of a drop rate of an output.

The polymer electrolyte membrane 114 has the role of separating the fuel electrode 102 and the oxidant electrode 108 and also moving the hydrogen ion between both of them. For this reason, the polymer electrolyte membrane 114 is desired to be the membrane in which an electrical conductivity of the hydrogen ion is high. Also, it is desired to be stable in chemistry and also high in mechanical strength. As the material constituting the polymer electrolyte membrane 114, the high polymeric organic substance is preferably used which has a strong acid group such as a sulfone group, a phosphoric acid group, a phosphonic group, a phosphine group and the like, and a weak acid group such as a carboxyl group and the like.

As the fuel electrode side collector 104 and the oxidant electrode side collector 110, it is possible to use the porous substrate such as a carbon paper, a carbon molding, a carbon sinter, a sintered metal, a foam metal and the like. As mentioned above, the stay of the gas bubbles of the carbon dioxide in the fuel electrode side collector 104 causes the drop in the efficiency of the electric power production. This stay of the gas bubbles is caused by the fact that the water covering the gas bubbles is adhered and kept on the fuel electrode side collector 104. So, the surface process using the hydrophilic coating material or the hydrophobic coating material is desired to be performed on the surface of the fuel electrode side collector 104. The execution of the surface process using the hydrophilic coating material increases the flow behavior of the fuel on the surface of the fuel electrode side collector 104. Consequently, the gas bubbles of the carbon dioxide are easily moved together with the fuel. Also, the execution of the process using the hydrophobic coating material can reduce the deposition of the water on the surface of the fuel electrode side collector 104, which causes the formation of the gas bubbles. Thus, the formation of the gas bubbles can be reduced on the surface of the fuel electrode side collector 104. Moreover, the combined action of the action through those surface processes and the above-mentioned vibration enables the carbon dioxide to be further efficiently removed from the fuel electrode, which attains the high efficiency of the electric power production. As the hydrophilic coating material, for example, it is possible to list titanium oxide, silicon oxide and the like. On the other hand, it is possible that the hydrophobic coating material is exemplified in poly-tetra-fluoro-ethylene, silane and the like.

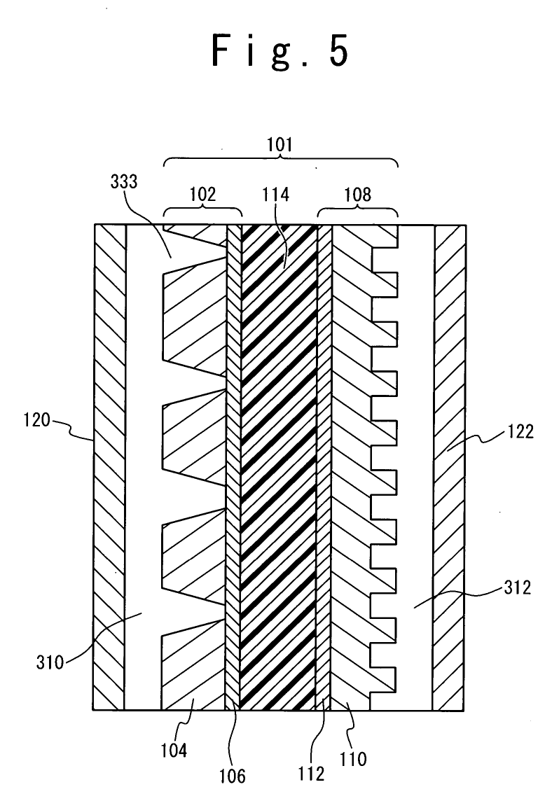

FIG. 5 is another sectional view showing a generating portion of the fuel cell main unit in FIG. 1.

Also, as shown in FIG. 5, a tapered penetration hole 333 may be made in the fuel electrode side collector 104. Such configuration leads to the effect combined with the above-mentioned vibration. The gas bubbles of the carbon dioxide are further easily moved to the fuel path 310 from the fuel electrode side collector 104. Thus, it is possible to attain the smooth reaction in the fuel electrode.

Such the fuel electrode side collector 104 can be manufactured, for example, as follows. A stainless steel plate is selected as the collector. Then, a penetration hole is made in this stainless steel plate by using a drill having a diameter of 1 mm. Next, a drill having a diameter of 2 mm is used to perform a spot facing operation on the penetration hole. Consequently, the tapered penetration hole 333 can be made.

The fuel electrode side collector 104 can be also manufactured by carrying out the same method to the above-mentioned porous substrate, if the shape of the porous substrate is stable.

The catalyst of the fuel electrode 102 is exemplified in platinum, rhodium, palladium, iridium, osmium, ruthenium, rhenium, gold, silver, nickel, cobalt, lithium, lanthanum, strontium, yttrium and the like, an alloy of platinum and at least one of ruthenium, gold and rhenium and the like. On the other hand, as the catalyst of the oxidant electrode 108, it is possible to use the catalyst similar to that of the fuel electrode 102. So, the above exemplified substances can be used. The catalysts of the fuel electrode 102 and the oxidant electrode 108 may be equal or different.

The carbon particle for supporting the catalyst is exemplified in an acetylene black (Denka Black (a registered trademark, made by Denki Kagaku Kogyo K.K.), XC72 (made by Vulcan Corporation) and the like), a carbon black, a ketjen black (made by Ketjen Black International K. K.), a carbon nano-tube, a carbon nano-horn and the like.

As the fuel for the fuel cell, for example, it is possible to use the organic liquid fuel such as methanol, ethanol, dimethyl ether and the like.

Although there is not a special limit on the method of manufacturing the fuel cell main unit 100, for example, it can be manufactured as follows.

At first, the catalyst is supported on the carbon particles. This step can be carried out by using a typically used impregnating method. Next, the carbon particles on which the catalyst are supported and the polymer electrolyte particles, for example, such as NAFION (a registered trademark, made by Du Pont K. K.) are dispersed into solvent and made into paste. Then, this is coated on the substrate and dried so that the catalyst layer can be obtained. After the paste is coated, it is heated at a heating temperature for a heating time, correspondingly to fluorine resin to be used. Consequently, the fuel electrode 102 or the oxidant electrode 108 is manufactured.

The polymer electrolyte membrane 114 can be manufactured by employing a proper method, depending on the usage material. For example, the liquid in which the high polymeric organic substance is solved or dispersed into the solvent is cast and dried on a strippable sheet such as poly-tetra-fluoro-ethylene and the like.

Consequently, this can be obtained.

The polymer electrolyte membrane 114 as manufactured above is sandwiched between the fuel electrode 102 and the oxidant electrode 108 to thereby obtain the electrode-electrolyte assembly 101.

The piezoelectric vibrator 314 can be directly fixed on the surface of the fuel cell main unit 100, as shown in FIG. 1. However, both of them do not need to be always adjacent to each other. For example, the fuel cell main unit 100 and the piezoelectric vibrator 314 may be separately fixed on one substrate. This is because the above-mentioned effect can be obtained since the vibration of the piezoelectric vibrator 314 is transmitted through this substrate to the fuel cell main unit 100.

In the above-mentioned explanation, the mechanism of using the piezoelectric vibrator 314 as the vibration generating unit has been described. However, this is not limited thereto. For example, a vibrating motor can be employed as the vibration generating unit. The vibrating motor is exemplified in FM23A, CM5M made by Akizuki Densi Tsusho Co., Ltd., and FF-H30WA, RF-J20WA made by Mabuchi Motor, Co., Ltd., and the like. The vibrating motor usually generates the vibration under the direct current. For this reason, if the vibrating motor is used as the vibration generating unit, the inverter device can be omitted to thereby provide the simpler configuration.

(Second Embodiment)

In this embodiment, the portable telephone as one of portable information devices using the power supply as the fuel cell including the vibration generating unit is described. Here, portable information devices are exemplified in a portable telephone, a note type of a personal computer and PDA (personal digital assistant).

Conventionally, there is the portable telephone having a function of reporting an incoming to a user through a vibration caused by a vibrating motor and the like. The portable telephone in this embodiment is characterized in that the above-mentioned vibrating motor is used also as the vibration generating unit.

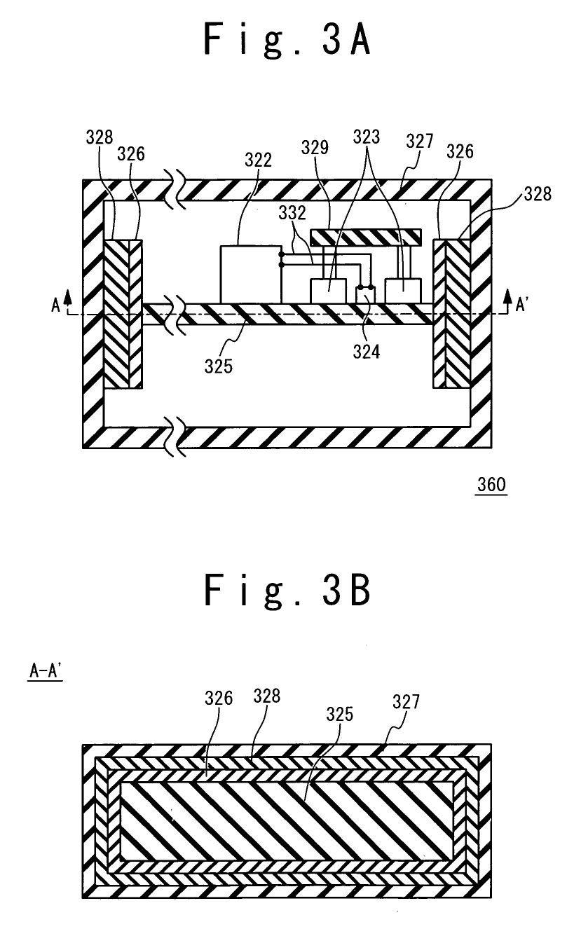

FIG. 3A is a sectional view showing a portable telephone as one of portable information devices in this embodiment, and shows only a main portion regarding this embodiment.

The portable telephone 360 includes an outer body 327 and an inner body 326. As shown in FIG. 3A, a vibration damping material 328 is sandwiched between an outer wall of the inner body 326 and an inner wall of the outer body 327. Under this condition, the outer body 327 and the inner body 326 are joined to each other. The substrate 325 is fixed inside the inner body 326. The fuel cell 322, a plunger 323 and a vibrating motor 324 are placed on the substrate 325. Also, a pad 329 having no vibration damping property is placed on the plunger 323. The same components similar to those described in the first embodiment can be used in the fuel cell 322. The fuel cell 322 and the vibrating motor 324 are electrically connected through a wiring 332 to each other.

FIG. 3B is a AA′ sectional view of FIG. 3A. This is configured such that the vibration damping material 328 is placed around the inner body 326, and the outer body 327 is further positioned on the outer side thereof.

Similarly to the fuel cell described in the first embodiment, a part of an output of the fuel cell 322 is supplied to the vibrating motor 324. Consequently, a vibration is generated from the vibrating motor 324. Since this vibration is transmitted through the substrate 325 to the fuel cell 322, the carbon dioxide is effectively removed from a fuel electrode inside the fuel cell 322. This results in the attainment of the smooth operation of the fuel cell 322. Incidentally, FIGS. 3A and 3B show the state at the time of non-incoming. Although the vibration generated from the vibrating motor 324 is transmitted through the substrate 325 to the inner body 326, the vibration is absorbed by the vibration damping material 328. Thus, since the vibration is not transmitted to the outer body 327, the user never feels the vibration.

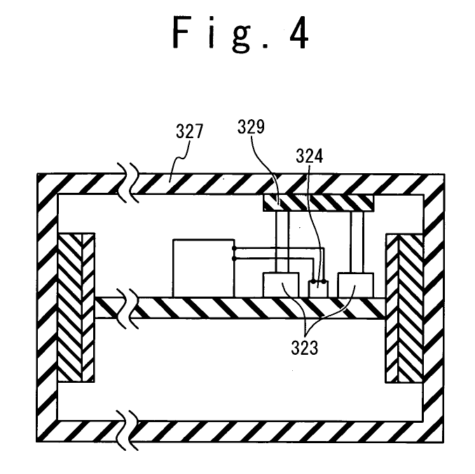

FIG. 4 is another sectional view showing a portable telephone as one of portable information devices in this embodiment, and shows only a main portion regarding this embodiment. FIG. 4 shows the state at a time of an incoming. The plunger 323 pushes up the pad 329 so that the pad 329 and the outer body 327 are adhered to each other. Thus, since the vibration from the vibrating motor 324 is transmitted to the outer body 327, the user feels the vibration and knows the incoming fact. The switching between FIG. 3A and FIG. 4 can be carried out by the plunger 323 controlled by a central processing unit (not shown) that is, for example, an information processing unit typically (conventionally) included in the portable telephone.

As the vibration damping material 328, for example, it is possible to use a butyl rubber based vibration damping material, such as ZETRO vibration damping sheet made by Iida Sangyo K.K. and the like, a vibration protecting rubber U-NBC made by the same and the like. Also, the plunger 323 is exemplified in a small plunger MA series made by TDK K.K. As the pad 329, a material having a high friction coefficient is desired in order to effectively transmit the vibration to the outer body 327. For example, it is exemplified in a silicon rubber material.

The vibrating motor 324 is exemplified in FM23A, CM5M made by Akizuki Densi Tsusho Co., Ltd., and FF-H30WA, RF-J20WA made by Mabuchi Motor, Co., Ltd., and the like.

Also, instead of the vibrating motor 324, it is also possible to use the inverter device and the piezoelectric vibrator described in the first embodiment.

### EXAMPLE

This embodiment will be described below with reference to FIGS. 1 and 2.

In FIG. 1, the fuel cell includes the piezoelectric vibrator 314 as the vibration generating unit and the inverter device 316 as the electric power converting (supplying) unit. The inverter device 316 converts apart of the output of the fuel cell main unit 100 into the alternating current, and this alternating current is used to drive the piezoelectric vibrator 314. In FIG. 2, as the catalyst contained in the fuel electrode side catalyst layer 106 and the oxidant electrode side catalyst layer 112, the catalyst supporting carbon micro particles in which an alloy of platinum (Pt) and ruthenium (Ru) that have a particle diameter of 3 to 5 nm was supported at a weight ratio 50% on a carbon micro particles (Denka black; made by Denki Kagaku Kogyo K. K.) . Incidentally, the alloy composition was 50 at % Ru, and the weight ratio of the alloy to the carbon micro particles was 1:1. Then, Swt % NAFION solution 18 ml made by Aldrich Chemical K. K. was added to this catalyst supporting carbon particle of 1 g. Then, it was agitated in a supersonic mixer at 50° C. for three hours and made into catalyst paste. This paste was coated by 2 mg/cm² on a carbon paper (TGP-H-120 made by Toray Industries, Inc.), on which the water repelling process using the poly-tetra-fluoro-ethylene was performed, by using a screen printing method. Then, it was dried at 120° C., and the fuel electrode 102 and the oxidant electrode 108 were formed.

Next, the fuel electrode 102 and the oxidant electrode 108, which were generated as mentioned above, were thermally pressed on one sheet of the polymer electrolyte membrane 114 (NAFION made by Du Pont K. K. (Registered Trademark) and a membrane thickness of 150 μm) at 120° C., and a unit fuel cell was manufactured.

Eight unit fuel cells as mentioned above were laminated through the oxidant electrode side separator 122 and the fuel electrode side separator 120 made of stainless steel and connected in series. Consequently, the fuel cell main unit 100 was manufactured.

The wiring was established from the plus terminal and the minus terminal of the thus-generated fuel cell main unit 100 through the branching unit (not shown) to the first plus terminal 318 and the first minus terminal 319, and the second plus terminal 320 and the second minus terminal 321. Moreover, the inverter device 316 and the fuel cell main unit 100 were connected through the second plus terminal 320 and the second minus terminal 321. Also, the inverter device 316 and the piezoelectric vibrator 314 were electrically connected, and the piezoelectric vibrator 314 was fixed on the side of the fuel cell main unit 100 by using an adhesive tape.

When a 10% methanol water solution was supplied at a rate of 2 ml/minute to the fuel electrode of the fuel cell main unit 100, it was confirmed that the electric power was produced in the fuel cell main unit 100 and that the piezoelectric vibrator 314 was vibrated. Next, when the output property between the first plus terminal 318 and the first minus terminal 319 was examined, a current value of 270 mA was measured at a voltage of 4.0 V, and this output was not changed even after 10 hours.

### (COMPARISON EXAMPLE)

The fuel cell in this comparison example was designed such that the inverter device 316, the piezoelectric vibrator 314, the second plus terminal 320, the second minus terminal 321 and the branching unit (not shown) are removed from the fuel cell in the above-mentioned example. The 10% methanol water solution was supplied at a rate of 2 ml/minute to the fuel electrode of this fuel cell. At this time, when the output property between the plus terminal and the minus terminal was examined, a current value of 300 mA was measured at a voltage of 4.0 V. However, this output was dropped with time. After 10 hours, it was 50% of the output.

From the above-mentioned data of the fuel cell in the example and the comparison example, it is understood that the output property of the fuel cell in the example is superior to that of the fuel cell in the comparison example. In the fuel cell in the example, the cell reaction is considered to be smoothly progressed since the vibration of the piezoelectric vibrator 314 effectively removes the carbon dioxide induced in the fuel electrode.

As mentioned above, according to the present invention, it is possible to provide the fuel cell in which since the fuel cell main unit includes the vibration generating unit, the carbon dioxide is efficiently removed from the fuel electrode, and the stable output is obtained.

1. A fuel cell comprising:
a fuel cell main unit which includes a fuel electrode and an oxidant electrode, and generates electric power based on supplying of organic liquid fuel to said fuel electrode and oxidant to said oxidant electrode; and
a vibration generating unit which generates vibration to vibrate said fuel electrode such that carbon dioxide generated at said fuel electrode is removed.

2. The fuel cell according to claim 1, further comprising:
a control unit which controls an operation of said vibration generating unit based on an output of said fuel cell main unit.

3. The fuel cell according to claim 1, further comprising:
a power applying unit which outputs alternating electric power to said vibration generating unit, wherein said vibration generating unit is driven by said alternating electric power.

4. The fuel cell according to claim 1, wherein said vibration generating unit is driven by a part of an output of said fuel cell main unit.

5. The fuel cell according to claim 1, wherein said vibration generating unit includes a piezoelectric vibrator which generates said vibration.

6. The fuel cell according to claim 1, wherein said vibration generating unit is arranged on said fuel cell main unit.

7. The fuel cell according to claim 1, further comprising:
a holding substrate on which holds said fuel cell main unit and said vibration generating unit,
wherein said holding substrate transmits said vibration to said fuel cell main unit.

8. The fuel cell according to claim 1, wherein said fuel cell main unit includes a porous current collector that is coated by hydrophilic coating material.

9. The fuel cell according to claim 1, wherein said fuel cell main unit includes a porous current collector that is coated by hydrophobic coating material.

10. The fuel cell according to claim 1, wherein said fuel electrode includes:
a current collector, and
a fuel electrode catalyst layer of which one side is connected to said current collector and another side is connect to a polymer electrolyte membrane,
said current collector has holes which penetrate said current collector, diameters of said holes at a side of said fuel electrode catalyst layer are smaller than those at an opposite side.

11. A potable information device comprising:
a body; and
a fuel cell which is held on said body,
wherein said fuel cell comprising:
a fuel cell main unit which is arranged in said body, includes a fuel electrode and an oxidant electrode, and generates electric power based on supplying of organic liquid fuel to said fuel electrode and oxidant to said oxidant electrode, and
a vibration generating unit which is arranged in said body and generates vibration to vibrate said fuel electrode such that carbon dioxide generated at said fuel electrode is removed.

12. The potable information device according to claim 11, wherein said fuel cell further comprises:
a control unit which controls an operation of said vibration generating unit based on an output of said fuel cell main unit.

13. The potable information device according to claim 12, wherein said fuel cell further comprises:
a power applying unit which outputs alternating electric power to said vibration generating unit, wherein said vibration generating unit is driven by said alternating electric power.

14. The potable information device according to claim 11, wherein said vibration generating unit is driven by a part of an output of said fuel cell main unit.

15. The potable information device according to claim 11, wherein said vibration generating unit includes a piezoelectric vibrator which generates said vibration.

16. The potable information device according to claim 11, wherein said vibration generating unit is arranged on said fuel cell main unit.

17. The potable information device according to claim 11, wherein said fuel cell further comprises:
a holding substrate on which holds said fuel cell main unit and said vibration generating unit, and
said holding substrate transmits said vibration to said fuel cell main unit.

18. The potable information device according to claim 11, wherein said fuel cell main unit includes a porous current collector that is coated by hydrophilic coating material.

19. The potable information device according to claim 11, wherein said fuel cell main unit includes a porous current collector that is coated by hydrophobic coating material.

20. The potable information device according to claim 11, wherein said fuel electrode includes:
a current collector, and
a fuel electrode catalyst layer of which one side is connected to said current collector and another side is connect to a polymer electrolyte membrane,
said current collector has holes which penetrate said current collector, diameters of said holes at a side of said fuel electrode catalyst layer are smaller than those at an opposite side.

21. The potable information device according to claim 11, wherein said body includes:
an outer body,
an inner body which is contained in said outer body, and
a vibration damping material which connects said outer body and said inner body,
said fuel cell is held on said inner body.

22. The potable information device according to claim 21, further comprising:
an information notifying unit which is arranged on said inner body, transmits said vibration to said outer body and notifies information to a user by vibrating said outer body based on said vibration.

23. The potable information device according to claim 11, wherein said vibration generating unit is combined with a information notifying unit which transmits said vibration to said body and notifies information to a user by vibrating said body based on said vibration.

24. The potable information device according to claim 21, wherein said vibration damping material includes butyl rubber.

25. A cellular phone comprising:
a body; and
a fuel cell which is held on said body,
wherein said fuel cell comprising:
a fuel cell main unit which is arranged in said body, includes a fuel electrode and an oxidant electrode, and generates electric power based on supplying of organic liquid fuel to said fuel electrode and oxidant to said oxidant electrode, and
a vibration generating unit which is arranged in said body and generates vibration to vibrate said fuel electrode such that carbon dioxide generated at said fuel electrode is removed,
said vibration generating unit is combined with a information notifying unit which transmits said vibration to said body and notifies information to a user by vibrating said body based on said vibration.

26. An operation method of a fuel cell, comprising:
(a) generating electric power by supplying organic liquid fuel to a fuel electrode and oxidant to an oxidant electrode of said fuel cell; and
(b) vibrating said fuel electrode such that carbon dioxide generated at said fuel electrode is removed.

27. The operation method of a fuel cell according to claim 26, wherein said vibration is generated by a piezoelectric vibrator to which alternating current is supplied.

28. The operation method of a fuel cell according to claim 26, wherein said vibration is generated by using a part of output current of said fuel cell.

29. The operation method of a fuel cell according to claim 26, wherein said step (b) comprises:
(b1) vibrating said fuel electrode when an output of said fuel cell is lower than a threshold value.
